(19) United States
(12) Patent Application Publication
(10) Pub. No.: US 2017/0126550 A1
(43) Pub. Date: May 4, 2017

(54) SELECTING A FLOW DATA SOURCE

(71) Applicant: CA, Inc., New York, NY (US)

(72) Inventors: Joseph Elisha Taylor, Fort Collins, CO (US); Aby Paul, Fort Collins, CO (US)

(21) Appl. No.: 14/927,167

(22) Filed: Oct. 29, 2015

(51) Int. Cl. H04L 12/721; H04L 29/08; H04L 12/26; H04W 28/02; H04L 12/24

(52) U.S. Cl. CPC H04L 45/38; H04W 28/0289; H04L 41/0654; H04L 43/0882; H04L 69/325

(57) ABSTRACT

To avoid inflated measurements, a flow data analyzer can select a single source of flow data to use when determining network traffic measurements for a given host. By selecting a single source of flow data, the flow data analyzer reduces the chance of redundant flow data causing inflated measurements. To select a flow data source for a host, the flow data analyzer analyzes flow data received from network devices and selects a network device based on a flow data source criterion. Examples of a flow data source criterion include a network device's sample rate or an amount of flow data for the host captured by the network device. Once a flow data source is selected, the flow data analyzer uses flow data generated by the selected source. The flow data analyzer may select a different flow data source for each host being monitored by the network manager.

### BACKGROUND

The disclosure generally relates to the field of computer systems, and more particularly to network monitoring systems.

Network devices, such as routers or switches, can capture data which indicates the flow of network traffic. For example, one or more intervening routers can capture flow data that indicates network traffic between two hosts. The flow data can include information such as source and destination Internet Protocol (“IP”) addresses, source and destination ports, Layer 3 protocol type, number of packets, number of bytes per packet, etc. A network device may capture flow data for each packet that flows through the network device or may capture flow data according to a sample rate, such as 1 out of every 100 packets. The network devices periodically export the captured flow data to flow data collectors and software applications for analysis (“flow data analyzers”). A flow data analyzer analyzes the flow data to determine network traffic measurements or other indicators of network performance.

### BRIEF DESCRIPTION OF THE DRAWINGS

Embodiments of the disclosure may be better understood by referencing the accompanying drawings.

FIG. 1 depicts an example flow data collection system including a flow data analyzer.

FIG. 2 depicts a flow diagram of example operations for determining measurements for each host in a network.

FIG. 3 depicts a flow diagram of example operations for selecting a flow data source for a host.

FIG. 4 depicts an example flow data collection system including a flow data analyzer that maintains a flow data log.

FIG. 5 depicts a flow diagram of example operations for maintaining a flow data log for a host.

FIG. 6 depicts an example computer system with a flow data source selector.

### DESCRIPTION

The description that follows includes example systems, methods, techniques, and program flows that embody aspects of the disclosure. However, it is understood that this disclosure may be practiced without these specific details. For instance, this disclosure refers to network devices that capture flow data based on transport layer protocols in illustrative examples. But aspects of this disclosure can be applied to network devices that analyze network traffic based on application layer protocols, such as Hypertext Transfer Protocol (“HTTP”). In other instances, well-known instruction instances, protocols, structures and techniques have not been shown in detail in order not to obfuscate the description.

### TERMINOLOGY

The description below uses the term “flow data” or “network traffic data” to refer to data related to the flow of IP network traffic. A flow is a unidirectional sequence of packets that share a set of values or properties such as ingress interface, source IP address, destination IP address, IP protocol, source port, destination port, etc. Network traffic can be packetized according to transport layer protocols (i.e. Layer 3 protocols) such as the Transmission Control Protocol (“TCP”) or the User Datagram Protocol (“UDP”). Network devices that implement transport layer protocols are capable of capturing flow data. A flow record can include information such as source and destination IP addresses, source and destination ports, number of packets, number of bytes per packet, a timestamp for a flow's start time, a timestamp for a flow's finish time or duration, etc. Flow data can include a single flow record or may include multiple flow records. Although the term “flow data” is used herein, other literature may refer to similar data as “NetFlow,” “Mow,” “NetStream,” “AppFlow,” “Traffic Flow,” “Layer 3 data,” etc.

The description below uses the term “packet” to refer to protocol data units (“PDUs”). A PDU is a group of data that has been encapsulated in accordance with a particular protocol. For example, PDUs may be segments in TCP or datagrams in UDP. The term packet, as used herein, may refer to a variety of PDUs such as segments, datagrams, frames, or HTTP packets.

### INTRODUCTION

A flow data analyzer, when using flow data from multiple network devices, may inaccurately determine network traffic measurements. This inaccuracy can be caused by the same network traffic being represented multiple times in flow data. For example, a packet generated by a host may flow through five routers before reaching its destination. Each of the five routers may capture and export flow data related to the packet causing the same network traffic to be represented five times. As a result, the flow data analyzer, when attempting to determine an amount of traffic generated by the host, may end up with an inflated number, possibly five times larger in this example.

Overview

To avoid inflated measurements, a flow data analyzer can select a single source of flow data to use when determining network traffic measurements for a given host. The selected source of flow data may be a network device or network probe that can be programmed to capture flow data. Examples of network devices include a router and a switch. When determining measurements for the host, such as an amount of traffic received, the flow data analyzer uses flow data generated by the selected source and may exclude flow data generated by other sources. By selecting a single source of flow data, the flow data analyzer reduces the chance of redundant flow data causing inflated measurements. To select a flow data source for a host, the flow data analyzer analyzes flow data received from network devices and selects a network device based on a flow data source criterion. Examples of a flow data source criterion include a network device's sample rate or an amount of flow data for the host captured by the network device. For example, if a first router has a sample rate of 1/1 packets and a second router has a sample rate of 1/10 packets, the flow data analyzer can be programmed to select the first router based on the higher sample rate. However, if the first router captured flow data for five packets generated by the host and the second router captured flow data for ten packets generated by the host, the flow data analyzer may select the second router despite a the second router having a lower sample rate. Once a flow data source is selected, the flow data analyzer uses flow data generated by the selected source. The flow data analyzer may select a different flow data source for each host being monitored by the network manager.

Example Illustrations

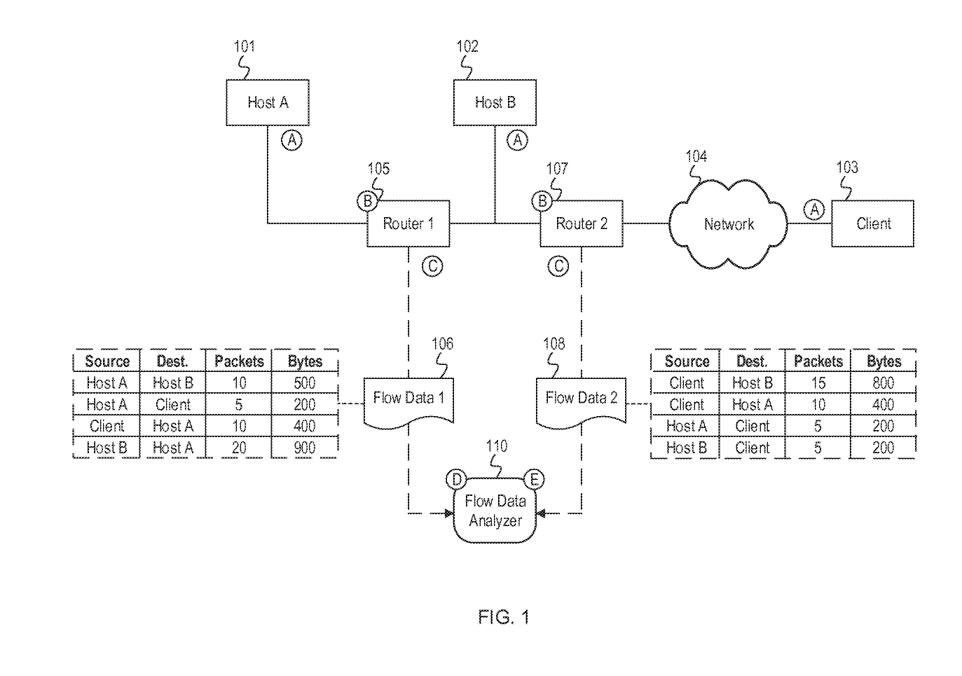

FIG. 1 is annotated with a series of letters A-E. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 1 depicts an example flow data collection system including a flow data analyzer. FIG. 1 depicts a host A 101 and a host B 102 that are communicatively coupled to a router 1 105 and a router 2 107 (hereinafter “the routers”). A client 103 communicates with the host A 101 and the host B 102 through a network 104. The router 1 105 and the router 2 107 communicate with a flow data analyzer 110.

At stage A, the host A 101, the host B 102, and the client 103 communicate through the network 104, the router 1 105, and the router 2 107. The network 104 may be a local network or a network such as the Internet. The router 1 105, the router 2 107, and the client 103 may connect to the network 104 through other devices not depicted such as a switch or firewall. Additionally, the router 1 105 and the router 2 107 may be network devices such as switches or other network devices capable of capturing flow data. The host A 101 and the host B 102 may be servers, databases, or computer systems that host applications, web resources, virtual machines, data, etc. The client 103 may be computer workstation, mobile computing device, server, or other device capable of communicating through the network 104. The host A 101, the host B 102, and the client 103 may communicate using various communication protocols including the TCP/IP Suite and UDP. The network traffic generated by the host A 101, the host B 102, and the client 103 flows through the routers. For example, network traffic between the client 103 and the host B 102 flow through the router 2 107, and network traffic between the host A 101 and the host B 102 flow through the router 1 105.

At stage B, the router 1 105 and the router 2 107 capture flow data related to the network traffic generated by the host A 101, the host B 102, and the client 103. While the host A 101, the host B 102, and the client 103 can communicate using application layer protocols such as HTTP, the routers process the network traffic at the transport layer (Layer 3 of the Internet Protocol Suite). Packets form the network traffic. The routers capture data related to individual network traffic packets to create flow data. The flow data collected by the routers can include information such as source and destination IP addresses, number of packets, number of bytes per packet, etc. The routers may capture the flow data from an ingress or egress IP interface, i.e. as the network traffic flows into a router or as the network traffic flows out of a router. The routers may not capture flow data for each packet that is received. For instance, routers may limit packets captured due to processing constraints or to limit the overall amount of flow data captured. Instead, the routers may sample one out of every n packets or determine a sample rate or sample frequency based on some other configuration. For example, the routers may use random sampling or adjust the sample rate based on network traffic volume.

At stage C, the routers export flow data 1 106 and flow data 2 108 to the flow data analyzer 110. The flow data analyzer 110 may be an application running on a server and may communicate with the routers through a local network or the Internet. The routers may export flow data to the flow data analyzer 110 using communication protocols such as UDP or Stream Control Transmission Protocol (“SCTP”). The timing or frequency with which the routers export the flow data can vary. For example, the routers may be configured to export flow data after the expiration of a time interval. In some implementations, the routers may export flow data after network traffic has not been received for a threshold time interval or after a TCP session terminates indicating the end of a conversation between network devices. The routers may export the flow data synchronously or independently in accordance with their individual configurations. Although depicted as exporting the flow data directly to the flow data analyzer 110, the routers may export flow data to a flow data collector (not depicted). The flow data collector then relays the flow data received from the routers to the flow data analyzer 110. Additionally, the routers may export flow data to a database that is accessed as needed by the flow data analyzer 110. As depicted in FIG. 1, the router 1 105 exports the flow data 1 106, and the router 2 107 exports the flow data 2 108.

The flow data 1 106 includes flow data for communications between the host A 101 and the host B 102 and communications between the host A 101 and the client 103. The flow data 1 106 includes four flow records. The first flow record contains flow data for network traffic from the host A 101, as indicated in the “Source” column, to the host B 102, as indicated in the “Dest.” column. For simplicity the Source and Destination columns merely include the names of the components depicted in FIG. 1. In an actual implementation, the host A 101, for example, may be identified by its IP address in the Source or Destination columns. The first flow record in the flow data 1 106 indicates that the host A 101 sent ten packets comprising 500 bytes to the host B 102. Although not depicted, the flow data 1 106 could include other information, such as a start timestamp, source and destination ports, protocol type, etc.

The flow data 2 108 includes flow data for communications between the host A 101 and the client 103 and communications between the host B 102 and the client 103. The flow data 2 108 does not include flow data for communications between the host A 101 and the host B 102 as that network traffic flows through the router 1 105. Similar to the flow data 1 106, the flow data 2 108 includes source, destination, packets, and byte information and may include other information, such as a start timestamp, source and destination ports, protocol type, etc.

At stage D, the flow data analyzer 110 analyzes the flow data 1 106 and the flow data 2 108 to select a flow data source for the host A 101 and the host B 102. In FIG. 1, the flow data sources are the router 1 105 and the router 2 107. The flow data analyzer 110 selects a single flow data source in order to prevent inflated network measurements. If the flow data analyzer 110 did not select a flow data source and considered flow data from both the router 1 105 and the router 2 107, some flows may be double counted. For example, if the flow data analyzer 110 was attempting to determine an amount of traffic generated by the host A 101, the flow data analyzer 110 could double count the flow from the host A 101 to the client 103, as this flow is captured in both the flow data 1 106 and the flow data 2 108. Specifically, the flow is in the second flow record of the flow data 1 106 and in the third flow record of the flow data 2 108. As a result, when summing the bytes generated by the host A 101, the flow data analyzer 110 would determine that the host A 101 generated 900 bytes of data (500+200+200), when the host A 101 actually generated just 700 bytes of data (500+200).

The flow data analyzer 110 selects either the router 1 105 or the router 2 107 based on selection criterion such as a sample rate of the routers or an amount of flow data captured for either the host A 101 or the host B 102. The selection is made on a host-by-host basis. The flow data analyzer 110 selects the router whose flow data most accurately represents the network traffic of a host as determined by a selection criterion. When selecting a flow data source for the host A 101, the flow data analyzer 110 may first determine which network devices capture flow data for the host A 101. In the FIG. 1 example, the flow data analyzer 110 determines that both the router 1 105 and the router 2 107 are sources of flow data for the host A 101. Since there is more than one flow data source, the flow data analyzer 110 further analyzes the flow data 1 106 and the flow data 2 108 to select between the router 1 105 or the router 2 107.

The flow data analyzer 110 compares the sample rates between the router 1 105 and the router 2 107 and may select the router with the highest sample rate. For example, if the router 1 105 has a sample rate of 1/5 packets and the router 2 107 has a sample rate of 1/100 packets, the flow data analyzer 110 selects the router 1 105 because the router 1 105 has a higher sampling rate. The higher sampling rate indicates that the router 1 105 may capture flow data that more accurately represents the network traffic of the host A 101. In some instances, the sample rates of the routers may be identical or may not be comparable. For example, if the router 1 105 employs a random sample rate, the random sample rate cannot be compared to a sample rate of the router 2 107. In such instances, the flow data analyzer 110 may also analyze the flow data 1 106 and the flow data 2 108 to determine which of the routers captured the most flow data for the host A 101.

The flow data analyzer 110 determines which of the routers captured the most flow data by comparing the amount of flow data for the host A 101 found in the flow data 1 106 to the amount of flow data for the host A 101 found in the flow data 2 108. The comparison may be based on a total number of packets generated and/or received by the host A 101, on a total number of bytes generated and/or received by the host A 101, etc. If based on a total number of packets generated by the host A 101, the flow data analyzer 110 sums and compares the total number of packets generated by the host A 101 as found in the flow data 1 106 and as found in the flow data 2 108. As depicted in FIG. 1, the flow data 1 106 includes 15 packets (10+5) generated by the host A 101, and the flow data 2 108 includes 5 packets generated by the host A 101. Based on the comparison, the flow data analyzer 110 determines that the router 1 105 has captured more flow data for the host A 101 than the router 2 107. Since the router 1 105 captured more flow data, the flow data analyzer 110 would select the router 1 105 to be the flow data source for the host A 101.

The flow data analyzer 110 repeats the selection process for the host B 102. The flow data analyzer 110 determines that both routers capture flow data for the host B 102. Next, the flow data analyzer 110 compares the sample rates. If a router cannot be selected based on a sample rate, the flow data analyzer 110 compares amounts of flow data for the host B 102 captured by each of the routers. For example, if basing the comparison on the number of bytes generated by the host B 102, the flow data analyzer 110 compares 900 bytes for the host B 102 of the flow data 1 106 to 200 bytes for the host B 102 of the flow data 2 108. Based on this comparison, the flow data analyzer 110 would choose the router 1 105 to be the flow data source for the host B 102. If the comparison is based on the number of bytes received by the host B 102, the flow data analyzer 110 compares 500 bytes of the flow data 1 106 to 800 bytes of the flow data 2 108. Based on this comparison, the flow data analyzer 110 selects the router 2 107 to be the flow data source for the host B 102.

The flow data analyzer 110 may limit the comparison of flow data to flow data captured by the routers within a time window. For example, the flow data analyzer 110 may only compare flow data captured within the last minute. The duration of the time window may be based on the frequency with which the routers export flow data. For example, if the routers export flow data every two minutes, the time window may be two minutes. Also, the time window may be based on an amount of flow data being captured. If a large amount of flow data is captured, the flow data analyzer 110 may shorten the time window so less data is analyzed and compared when determining which of the routers to select.

Once a flow data source is selected for a host, flow data captured and exported by the flow data source is used for determining measurements for the host. For example, if the router 1 105 was selected to be the flow data source for the host A 101, the flow data analyzer 110 uses the flow data 1 106 and other flow data generated by the router 1 105. The flow data source selection process may be repeated at periodic intervals to adjust for changing network conditions. Additionally, the selection process may be repeated upon failure of a network device or addition of a network device.

At stage E, the flow data analyzer 110 determines network traffic measurements for the host A 101 and the host B 102. The flow data analyzer 110 may be configured to determine various measurements, such as the number of packets generated or received, bytes of data generated or received, number of flows, amount of traffic received or sent to a client, etc. When determining the measurements, the flow data analyzer 110 uses flow data from a flow data source selected for a host. In FIG. 1, if the flow data analyzer 110 selected the router 1 105 to be the source of flow data for host A 101, the flow data analyzer 110 uses the flow data 1 106 and any other flow data (not depicted) that may have been exported by the router 1 105 to determine measurements for the host A 101. For example, if the measurement to determine is the bytes of traffic generated by the host A 101, the flow data analyzer 110 adds 500+200 from the first two flow records of the flow data 1 106 and determines the measurement of 700 bytes for the host A 101.

The flow data analyzer 110 may supply the determined measurements to a user interface for display or to a network monitoring application for further analysis. The network monitoring application may use the determined measurements to identify network load balancing issues, determine that additional network devices or hosts are needed, identify irregular network traffic, etc.

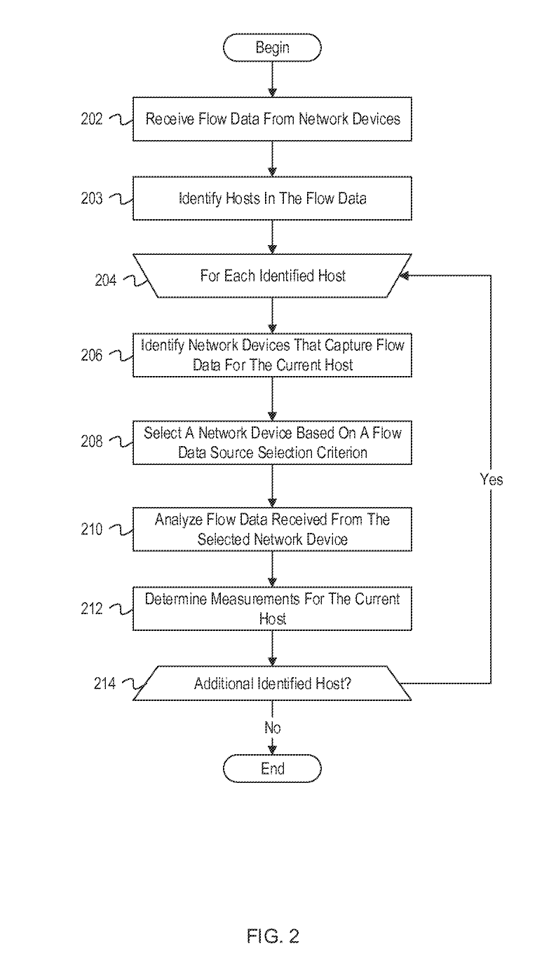

FIG. 2 depicts a flow diagram of example operations for determining measurements for each host in a network. FIG. 2 refers to a flow data analyzer as performing the operations for each of reading and consistency with FIG. 1.

The flow data analyzer receives flow data from network devices (202). The flow data analyzer may receive flow data directly from the network devices or may receive flow data through an intervening flow data collector. For example, multiple network devices within a network can export flow data to a flow data collector. The flow data collector then relays the flow data to the flow data analyzer. The flow data analyzer may store the flow data in a database or may load the received flow data into memory of a system running the flow data analyzer.

The flow data analyzer identifies hosts in the received flow data (203). The flow data analyzer may not have identifying information for hosts in a network. Additionally, even if the flow data analyzer has identifying information, some hosts in the network may not have recently generated traffic or may not generate traffic that flows through a network device that captures flow data. As a result, the flow data analyzer analyzes the received flow data to identify hosts in a network that are generating traffic. The flow data analyzer may identify hosts by determining all of the unique IP addresses generating traffic within the network. The flow data analyzer may filter the unique IP addresses to avoid identifying communication endpoints external to the network, such as clients or external servers, as hosts. For example, the flow data analyzer may be configured to only consider local IP addresses or IP addresses within a specified range to be hosts. In some implementations, identifying information, such as IP addresses, for hosts may be manually entered in the flow data analyzer. However, since network topology and configuration information are often unknown, the identifying information for hosts may not be available. Once hosts are identified, the flow data analyzer may store identifying information for the hosts for future use.

The flow data analyzer begins evaluating flow data for each identified host to select a flow data source and determine network traffic measurements (204). The flow data analyzer may select a flow data source and determine measurements for each host identified in the received flow data or may select a flow data source and determine measurements for a subset of the identified hosts. For example, the flow data analyzer may select a flow data source and determine measurements for hosts that generate traffic of a specified communication protocol or for hosts within a network address range. The flow data analyzer may not select a flow data source and determine measurements for hosts for which a flow data source has already been selected or for which measurements were determined within a time period. The host for which the flow data analyzer is currently selecting a flow data source and determining measurements is hereinafter referred to as “the current host.”

The flow data analyzer identifies network devices that capture flow data for the current host (206). Some of the network devices from which the flow data analyzer receives flow data may not capture flow data for the current host. For example, a network device may be located in a part of a network that cannot be reached by traffic generated by the current host. Additionally, a network device may be configured to only capture flow data for certain hosts. As a result, the flow data analyzer eliminates from the selection process network devices that do not capture flow data for the current host. The flow data analyzer determines that a network device does not capture flow data for the current host if identifying information for the current host does not appear in the flow data. For example, the flow data analyzer determines that the network device does not capture flow data for the host if the IP address of the host does not appear as a source or destination in the flow records.

The flow data analyzer selects a network device from the identified network devices based, at least in part, on a flow data source selection criterion (208). The flow data source selection criterion is used to select a network device which captures flow data that most accurately represents network traffic of the current host. Examples of the flow data source selection criterion include highest sample rate and largest amount of flow data captured for the host. The flow data analyzer selects one of the identified network devices based on the source selection criterion. The selected network device then serves as a flow data source for the current host.

The flow data analyzer analyzes the flow data received from the selected network device (210). The flow data analyzer retrieves flow data that was received from the selected network device. The retrieved flow data may include recently exported flow data or any flow data previously exported by the selected network device. The flow data may be stored in local storage or in a database communicatively coupled to the flow data analyzer. The flow data analyzer may retrieve flow data for a time period for which measurements are to be determined, may retrieve all flow data received, etc. The flow data analyzer may filter or sort the flow data in preparation for determining measurements for the current host. For example, the flow data analyzer may isolate flow records related to the current host, isolate flow records where the current host was the source, isolate flow records where the current host was the destination, or identify communications between the current host and a specific client.

The flow data analyzer determines network traffic measurements for the current host using the flow data received from the selected network device (212). For example, the flow data analyzer can determine the total amount of traffic generated or received by the current host, determine which client sent the most traffic to the current host, etc. The flow data analyzer determines measurements using flow data generated by the selected network device. The flow data analyzer may store determined measurements in a log, display them in a user interface, or supply them to a network monitoring application. Additionally, the flow data analyzer may use the determined measurements to identify network issues. For example, the flow data analyzer may identify a host whose amount of traffic generated exceeds a threshold, or the flow data analyzer may determine that an additional host is needed based on a total network load.

After determining measurements for the current host, the flow data analyzer determines whether there is an additional identified host (214). If there is an additional identified host, the flow data analyzer selects the next host (204). If there is not an additional host in the network, the process ends.

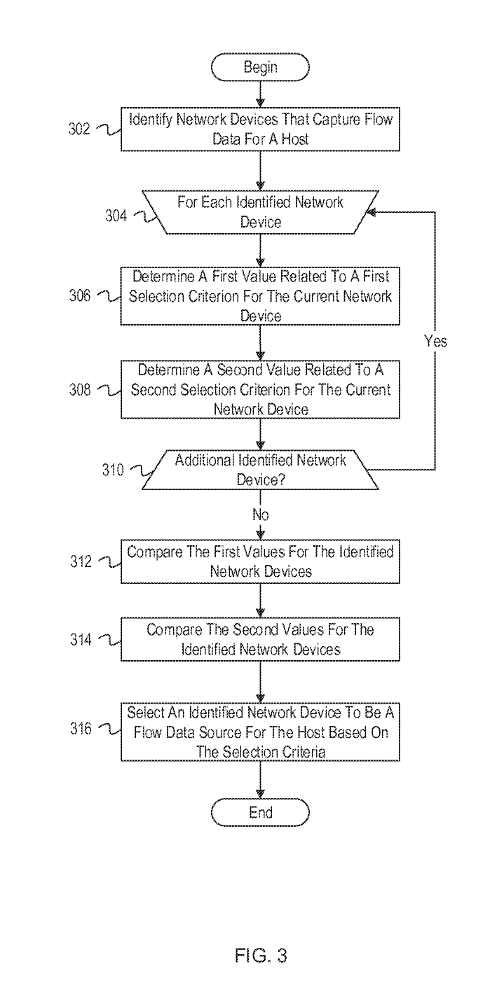

FIG. 3 depicts a flow diagram of example operations for selecting a network device to be a flow data source for a host. FIG. 3 refers to a flow data analyzer as performing the operations for each of reading and consistency with FIG. 1.

The flow data analyzer identifies network devices that capture flow data for a host (302). This operation is performed in a manner similar to that described at block 206 of FIG. 2.

A loop for each of the identified network devices begins (304). The loop may iterate over each identified network device. Alternatively, the loop may iterate until a network device that satisfies criteria is found. For example, the loop may iterate until a network device that satisfies a threshold for a sample rate or satisfies a threshold for an amount of flow data captured for the host is found. The network device currently being iterated over is hereinafter referred to as “the current network device.”

The flow data analyzer determines a first value related to a first selection criterion for the current network device (306). Examples of a selection criterion include highest sample rate or largest amount of captured flow data for the host. The flow data analyzer may be programmed to use highest sample rate as the first selection criterion or largest amount of flow data captured for the host as the first selection criterion. For the example operations of FIG. 3, it is assumed that the first selection criterion is highest sample rate. As a result, the first value related to the first selection criterion is the sample rate of the current network device. When exporting flow data, a network device typically includes its sample rate either in a header for the flow data or in flow records. The flow data analyzer can determine the sample rate for the current network device by processing the flow data header or flow records in flow data received from the current network device. Additionally, the flow data analyzer may communicate with the current network device to retrieve configuration information that indicates the sample rate for the current network device. In some instances, the flow data analyzer may have previously determined the sample rate for the current network device and stored the sample rate in memory of a system running the flow data analyzer. In such an instance, the flow data analyzer retrieves the sample rate from the system memory. In other instances, the flow data analyzer may be unable to determine a sample rate for the current network device. For example, the sample rate may not be identified in flow data, the flow data analyzer may be unable to communicate with the current network device, or the current network device may utilize a random sample rate. In such instances, the flow data analyzer may determine that a network device should selected using a second criterion or may exclude the current network device from the selection operations.

The flow data analyzer determines a second value related to a second selection criterion for the current network device (308). For the example operations of FIG. 3, it is assumed that the second selection criterion is largest amount of flow data captured for the host. As a result, the second value related to the second selection criterion is the amount of flow data captured for the host. The flow data analyzer determines the amount of flow data capture for the host during a time window. The flow data analyzer utilizes a time window to limit the amount of flow data that needs to be retrieved and analyzed to determine the amount of flow data captured for the host. Additionally, flow data retrieved within a recent time window better represents current network traffic flows. The flow data analyzer can be configured to use a time window such as the last minute, hour, day, etc. Also, the flow data analyzer may be programmed to determine the time window based on the frequency with which flow data is received from network devices. For example, if the identified network devices export flow data every thirty seconds, the flow data analyzer may determine the time window to be the last thirty seconds. The flow data analyzer may also adjust the time window to account for network latency. For example, if network traffic takes twenty milliseconds to flow from one network device to another, the flow data analyzer may extend the time window by twenty milliseconds to account for the latency. The flow data analyzer determines the amount of flow data captured for the host by first identifying flow records in the flow data of the current network device that pertain to the host and are within the time window. To identify flow records that pertain to the host, the flow data analyzer identifies flow records that contain the host IP address as a source or destination. The flow data analyzer utilizes timestamps of individual flow records in the flow data to identify the portion of the flow data that was captured within the time window. Alternatively, if the flow data is stored in a database, the flow data analyzer may query the database to retrieve flow records that pertain to the time window. Once the relevant flow records are identified, the flow data analyzer determines the total amount of flow data captured by either summing up the number of flow records, the total number of packets, or the total number of bytes represented in the flow data.

After determining the first value and the second value, the flow data analyzer determines whether there is an additional identified network device (310). If there is an additional identified network device, the flow data analyzer selects the next identified network device (304).

If there is not an additional identified network device, the flow data analyzer compares the first values for the identified network devices (312). In the FIG. 3 example, the flow data analyzer compares the sample rates of the identified network devices. Based on the comparison, the flow data analyzer identifies a network device with the highest sample rate. The network device with the highest sample rate is likely to have more accurate flow data and is given preference as a result (consider a network device that samples 1/1 packets and a network device that samples 1/1,000 packets). In some instances, the flow data analyzer may identify a number of potential network devices, such as network devices that satisfy a sample rate threshold. For example, the flow data analyzer may identify network devices that have at least a sample rate of 1/10 packets. Additionally, if there is a tie for the highest sample rate, the flow data analyzer may identify the tied network devices as potential flow data sources.

The flow data analyzer compares the second values for the identified network devices (314). In the FIG. 3 example, the flow data analyzer compares the amounts of flow data captured for the host by the identified network devices. The comparison may be based on the number of flow records, packets, or bytes captured by each of the identified network devices. Based on the comparison, the flow data analyzer identifies a network device with the largest amount of captured flow data for the host. The flow data analyzer may compare just the identified network devices that satisfied a sample rate threshold or were tied for highest sample rate.

The flow data analyzer selects a network device from the identified network devices to be a flow data source for the host based on the selection criteria (316). In the FIG. 3 example, the flow data analyzer selects the network device based on the first selection criterion of highest sample rate and the second selection criterion of largest amount of flow data captured for the host. In instances where multiple network devices are tied for the highest sample rate or multiple devices satisfy a sample rate threshold, the flow data analyzer may select from these network devices based on the comparison of amounts of captured flow data. In instances where a sample rate could not be determined for each of the identified network devices, the flow data analyzer may be unable to select a network device based on sample rates and may select a network device based solely on the amount of flow data captured for the host. After selecting the network device to be a flow data source, the process ends.

The operations for selecting a network device to be a flow data source for a host as described in FIG. 3 may be repeated periodically to accommodate for changing network conditions. For example, the operations may be repeated after the expiration of a time period or in response to an increase in network traffic. Additionally, the operations may be repeated upon failure of a network device or addition of a network device to a network.

In some implementations, the first selection criterion may be largest amount of flow data captured for the host, and the second selection criterion may be highest sampling rate. In some instances, a second selection criterion may not be used, and the selection of a network device may be based on a single selection criterion.

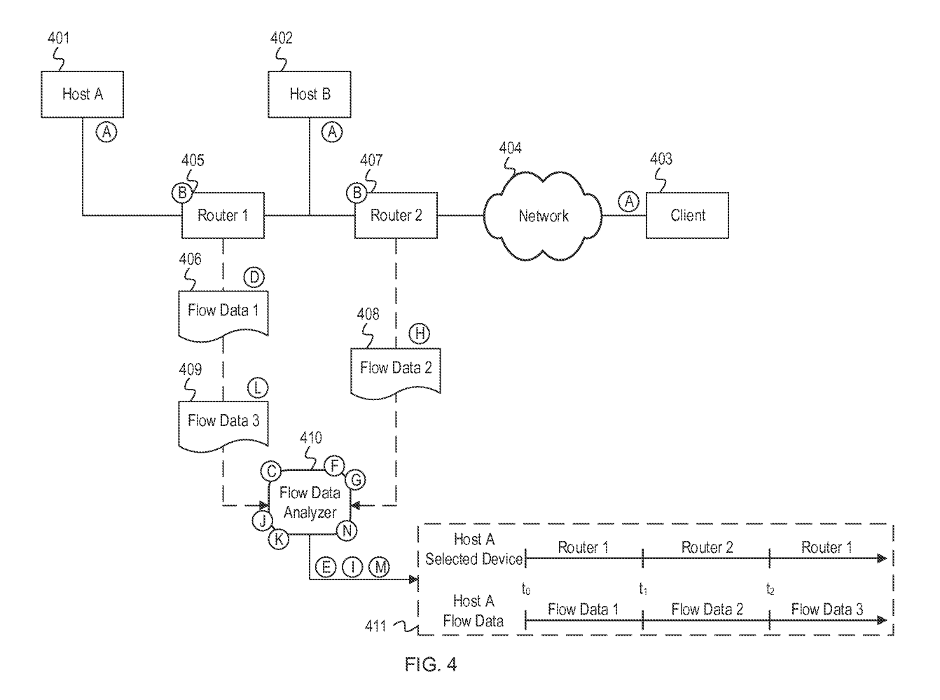

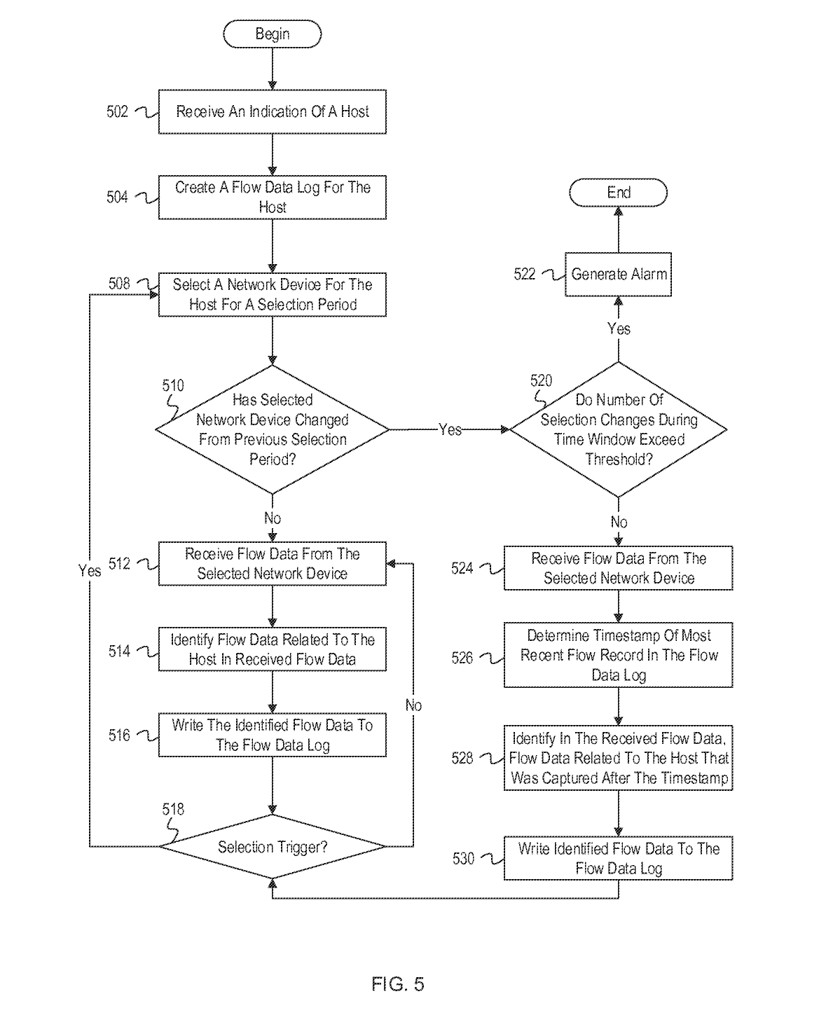

In the description above, the flow data analyzer uses flow data from a selected flow data source when determining network traffic measurements for a host. The flow data used by the flow data analyzer may include flow data recently received from the flow data source and historical flow data that was previously received from the flow data source and stored. The historical flow data may include flow data from time periods in which the currently selected flow data source was not the selected source, i.e. time periods in which another selected flow data source collected more accurate data for the host. To avoid the use of potentially inaccurate flow data, FIG. 4 and FIG. 5 describe a flow data log for a host that includes flow data from selected flow data sources over multiple time periods. Instead of using flow data from a single source, the flow data analyzer can determine network traffic measurements using flow data from the flow data log that contains accurate flow data for each of the time periods.

FIG. 4 is annotated with a series of letters A-K. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

FIG. 4 depicts an example flow data collection system including a flow data analyzer that maintains a flow data log. FIG. 4 depicts a host A 401 and a host B 402 that are communicatively coupled to a router 1 405 and a router 2 407. A client 403 communicates with the host A 401 and the host B 402 through a network 404. The router 1 405 and the router 2 407 communicate with a flow data analyzer 410.

At stage A, the host A 401, the host B 402, and the client 403 communicate through the network 404, the router 1 405, and the router 2 407 in a manner similar to that described at stage A of FIG. 1. At stage B, the router 1 405 and the router 2 407 capture flow data related to the network traffic generated by the host A 401, the host B 402, and the client 403 in a manner similar to that described at stage B of FIG. 1.

At stage C, the flow data analyzer 410 selects the router 1 405 to be a flow data source for the host A 401. The flow data analyzer 410 selects between the router 1 405 and the router 2 407 using operations similar to those depicted in FIG. 3. Once selected, the router 1 405 serves as the flow data source for the host A 401 until the flow data analyzer 410 determines that another flow data source should be selected. The flow data analyzer 410 indicates the selection of the router 1 405 as the flow data source in a flow data log 411. As depicted in FIG. 4, the flow data log 411 includes an indication for a time period beginning at time to that the “Host A Selected Device” is the router 1 405.

At stage D, the flow data analyzer 410 receives the flow data 1 406 from the router 1 405. The flow data analyzer 410 filters the flow data 1 406 to include just flow data that is related to the host A 401. The flow data analyzer 410 may filter the flow data by deleting flow records that are unrelated to the host A 401 from the flow data 1 406 or extracting flow records related to the host A 401 from the flow data 1 406.

At stage E, the flow data analyzer 410 writes the flow data 1 406 to the flow data log 411. Since the router 1 405 is the selected source for the host A 401, the flow data analyzer 410 writes flow data received from the router 1 405 that is related to the host A 401 to the flow data log 411. The flow data log 411 may be a table in a database, a file on a storage device, a buffer in memory, etc. In FIG. 4, the flow data log 411 depicts the flow data log 411 as including the flow data 1 406 for the time period beginning at time to. The flow data log 411 may include other flow data related to the host A 401 (not depicted) exported by the router 1 405 during the time period beginning at time to.

At stage F, the flow data analyzer 410 determines that a different flow data source should be selected for the host A 401. The flow data analyzer 410 may be programmed to perform the flow data source selection operations depicted in FIG. 3 in response to selection triggers. Examples of selection triggers include expiration of a time period, failure of a selected flow data source, addition of a flow data source to a network, or changes in network conditions. In FIG. 4, the flow data analyzer 410 performs the flow data source selection operations in response to a trigger at time t₁. The flow data analyzer 410 may have been triggered to perform the selection operations based on the expiration of the time period beginning at time to, failure of the router 1 405, a change in network conditions at time t₁, etc.

At stage G, the flow data analyzer 410 selects the router 2 407 to be a flow data source for the host A 401. After performing the flow data source selection operations, the flow data analyzer 410 determines the router 2 407 to be the selected flow data source for the host A 401 and indicates the selection of the router 2 407 as the flow data source in the flow data log 411. As depicted in FIG. 4, the flow data log 411 includes an indication for a time period beginning at time t₁ that the “Host A Selected Device” is the router 2 407.

At stage H, the flow data analyzer 410 receives the flow data 2 408 from the router 2 407. The flow data analyzer 410 filters the flow data 2 408 to just include flow data that is related to the host A 401. Additionally, the flow data analyzer 410 removes flow records from the flow data 2 408 that were captured prior to the time t₁. The flow data log 411 includes flow data from the router 1 405 until the time t₁. Prior to the time t₁, the router 2 407 may have captured flow data identical to flow data captured by the router 1 405. In order to avoid duplicate flow data in the flow data log 411, the flow data analyzer 410 modifies the flow data 2 408 to just include flow records captured after the time t₁.

At stage I, the flow data analyzer 410 writes the flow data 2 408 to the flow data log 411. Since the router 2 407 is the selected source for the host A 401, the flow data analyzer 410 writes flow data exported by the router 2 407 that is related to the host A 401 to the flow data log 411. In FIG. 4, the flow data log 411 depicts the flow data log 411 as including the flow data 2 408 for the time period beginning at time t₁. The flow data log 411 may include other flow data related to the host A 401 (not depicted) exported by the router 2 407 during the time period beginning at time t₁.

At stage J, the flow data analyzer 410 determines that a different flow data source should be selected for the host A 401. In response to receiving a selection trigger, the flow data analyzer 410 performs the flow data source selection operations at time t₂. The flow data analyzer 410 may have been triggered to perform the selection operations based on the expiration of the time period beginning at time t₁, failure of the router 2 407, a change in network conditions at time t₂, etc.

At stage K, the flow data analyzer 410 selects the router 1 405 to be a flow data source for the host A 401. After performing the flow data source selection operations at stage I, the flow data analyzer 410 determines that the router 1 405 should again be the selected flow data source for the host A 401 and indicates the selection of the router 1 405 as the flow data source in the flow data log 411. As depicted in FIG. 4, the flow data log 411 includes an indication for a time period beginning at time t₂ that the “Host A Selected Device” is the router 1 405.

At stage L, the flow data analyzer 410 receives the flow data 3 409 from the router 1 405. The flow data analyzer 410 filters the flow data 3 409 to just include flow data that is related to the host A 401. Additionally, the flow data analyzer 410 removes flow records from the flow data 3 409 that were captured prior to the time t₂. The flow data log 411 includes flow data from the router 2 407 until the time t₂. Prior to the time t₂, the router 1 405 may have captured flow data identical to flow data captured by the router 2 407. In order to avoid duplicate flow data in the flow data log 411, the flow data analyzer 410 modifies the flow data 3 409 just include flow records captured after the time t₂.

At stage M, the flow data analyzer 410 writes the flow data 3 409 to the flow data log 411. Since the router 1 405 is the selected source for the host A 401, the flow data analyzer 410 writes flow data exported by the router 1 405 that is related to the host A 401 to the flow data log 411. In FIG. 4, the flow data log 411 depicts the flow data log 411 as including the flow data 3 409 for the time period beginning at time t₂. The flow data log 411 may include other flow data related to the host A 401 (not depicted) exported by the router 1 405 during the time period beginning at time t₂.

At stage N, the flow data analyzer 410 determines network traffic measurements for the host A 401 using flow data from the flow data log 411. The flow data log 411 includes flow data from each of the flow data sources selected during the time periods beginning at time t₀, t₁, and t₂. As a result, the flow data log 411 contains a collection of flow data that should most accurately represents the network traffic of the host A 401 over the time periods. To increase accuracy of determined measurements, the flow data analyzer uses the flow data in the flow data log 411 to determine measurements instead of just flow data from the router 1 405 or just flow data from the router 2 407.

FIG. 5 depicts a flow diagram of example operations for maintaining a flow data log for a host. FIG. 5 refers to a flow data analyzer as performing the operations for each of reading and consistency with FIGS. 1 and 4.

The flow data analyzer receives an indication of a host (502). The flow data analyzer may identify the host in received flow data or may receive the indication of the host from a network monitoring application requesting network traffic measurements for the host. Additionally, the flow data analyzer may receive the indication of the host from a user or a configuration file.

The flow data analyzer creates a flow data log for the host (504). The flow data analyzer may create the flow data log by designating a storage location in a database, a storage device, in memory of a system running the flow data analyzer, etc. The flow data analyzer may create a file to be the log or create a directory where flow data is written.

The flow data analyzer selects a network device for the host for a selection period (508). The flow data analyzer selects the network device using selection operations similar to those described in FIG. 3. Additionally, the flow data analyzer may write an identifier for the selected network device to the flow data log or to memory and may write a timestamp indicating the time at which the selection was made. The network device is selected to be the flow data source for the host during the selection period. The selection period begins when the network device is selected and ends once the selection operations are again performed. For example, the flow data analyzer may select a first router to be the selected network device during a first selection period. The flow data analyzer may later determine that the selection operations should be performed again and, as a result of the operations, select a second router to be the selected network device for a second selection period. The second selection period begins when the second router is selected, and the first selection period ends when the flow data analyzer determined that the selection operations should again be performed. The flow data analyzer may determine that the selection operations should be performed in response to a flow data source selection trigger as described in more detail at process block 518.

The flow data analyzer determines whether the selected network device changed from a previous selection period (510). The selected network device changes when the selection operations performed at process block 508 result in a different network device being selected from the previous selection period. In the example described at process block 508, the flow data analyzer selected the first router to be the selected network device for the first selection period and then selected the second router to be the selected network device for the second selection period. After selecting the second router for the second selection period, the flow data analyzer would determine that the selected network device changed from a previous selection period, i.e. the second router is different than the first router from the first selection period. If the first router was selected to be the selected network device for the second selection period, the flow data analyzer would determine that the selected network device has not changed from the previous selection period, as the first router would be the selected network device in both the first and the second selection periods. The flow data analyzer may determine whether the selected network device has changed by comparing an identifier for the selected network device to an identifier for a selected network device from the previous selection period. The identifiers for the network devices may be read from the flow data log or from memory.

If the flow data analyzer determines that the selected network device has not changed from the previous selection period, the flow data analyzer receives flow data from the selected network device (512). The flow data analyzer may also receive flow data from the selected network device through a flow collector or may retrieve the flow data from a database or directly from the selected network device.

The flow data analyzer identifies flow data related to the host in the received flow data (514). The flow data analyzer identifies flow records in the received flow data that include an identifier for the host, such as the host's IP address. The flow data analyzer may be programmed to identify flow records for which the host is a source, a destination, or either one. The flow records that include an identifier for the host comprise the identified flow data related to the host.

The flow data analyzer writes the identified flow data to the flow data log (516). The flow data analyzer may write the identified flow data to a specified storage location, a memory address, a file, a database, etc. If writing to a database, the flow data analyzer may, for example, write each flow record contained in the identified flow data to a row in a database table. The flow data analyzer may write a subset of the information contained in the identified flow data, such as just a number of bytes generated or received by the host. The flow records in the identified flow data typically include a timestamp indicating when the flow record was captured. The flow data analyzer writes the timestamps for the flow records to the flow data log. In instances where a timestamp is not included for the flow records, the flow data analyzer may append a timestamp to the flow records indicating when the identified flow data was received or written to the flow data log.

If the flow data analyzer determined that the selected network device changed from the previous selection period (510), the flow data analyzer determines whether the number of changes in selected network device during a time window exceeds a threshold (520). The flow data analyzer tracks the number of changes in selected network device during the time window as frequent changes in selected network device can indicate erratic network traffic or network device failures. The time window is an amount of time, such as the previous five minutes. The threshold is a number of a changes in network device selection that if exceed indicates there may be a network issue. A time window and a threshold may be configured in the flow data analyzer. For example, the flow data analyzer may be configured to determine if there were more than five changes in selected network device in the previous one minute. Alternatively, the flow data analyzer may determine the length of the time window and the threshold based on the duration of a selection period. For example, the flow data analyzer may determine the time window to be six times longer than the selection period, e.g. if the selection period is ten seconds, the time window would be one minute. The threshold may then be based on the number of potential changes in selection during the time window or a fraction thereof. For example, the threshold may be one-half of potential changes, i.e. if there are six potential changes during the time window, the threshold is three.

The flow data analyzer may track changes in selected network device by reading selected network devices from the flow data log, maintaining a counter, or writing network device selections to an array. As described above, the flow data analyzer may be programmed to write a network device selection along with a timestamp of the selection to the flow data log. The flow data analyzer can then identify the network device selections that occurred within the time window using the timestamps and determine the number of changes by comparing the network device selections made at each selection period. Alternatively, the flow data analyzer may increment a counter each time a change in selected network device is determined and decrement the counter once a determined change is no longer within the time window. The flow data analyzer determines the number of changes based on the value of the counter. Additionally, the flow data analyzer may write each network device selection to an array. The array may be sized to contain a number of selections equal to a number of selection periods within the time window. For example, if there are six selection periods in a time window, the array would be of size six. Once a new selection is pushed onto the array, the oldest selection in the array is removed so that the array just includes selections that occurred within the time window. The flow data analyzer can then traverse the array comparing each selection to the previous selection in the array and determine a total number of changes in selection during the time window. Once the flow data analyzer determines a number of changes in selected network device during the time window, the flow data analyzer determines whether the number exceeds the threshold.

If the flow data analyzer determines that the number of changes in selected network device during the time interval exceeds the threshold, the flow data analyzer generates an alarm (522). The flow data analyzer may display an alarm through a user interface or may send the alarm to a network monitoring application. The alarm may indicate the number of changes in selected network device, which network devices were selected during the time window, and the host for which the network devices were being selected. A user or the network monitoring application can then use the information in the alarm to identify network issues. For example, the network monitoring application may determine that a communication interface of the host has failed. After the flow data analyzer generates the alarm, the process ends. Alternatively, in some implementations, the flow data analyzer may continue the operations at process block 524 after generating the alarm.

If the flow data analyzer determines that the number of changes in selected network device during the time interval does not exceed the threshold, the flow data analyzer receives flow data from the selected network device (524). The flow data analyzer may also receive flow data from the selected network device through a flow collector or may retrieve the flow data from a database or from the selected network device.

The flow data analyzer determines a timestamp of most recent flow record in the flow data log (526). As described above, the flow data log comprises flow records that include timestamps that indicate when the flow record was captured by a network device. The flow data analyzer identifies the timestamp associated with the most recent flow record. The timestamp indicates that the flow data log includes flow data up until the time indicated by the timestamp.

The flow data analyzer identifies flow data that is related to the host and was captured after the timestamp (528). The flow data analyzer identifies flow data related to the host in the received flow data in a manner similar to that described at process block 514. Additionally, the flow data analyzer determines which of the flow records in the received flow data were captured by the selected network device after the timestamp of the most recent flow record in the flow data log. Because the flow data log includes data up to the time indicated in the timestamp, the flow data analyzer excludes flow data captured before the timestamp, as this flow data may already be represented in the log. For example, if the flow data log included flow data from a previous selected network device up until a time t, flow data received from the current selected network device that was captured before time t may be the same as the flow data in the flow data log that was captured by the previous selected network device.

The flow data analyzer writes the identified flow data to the flow data log (530). The flow data analyzer writes the identified flow data to the flow data log in a manner similar to that described at process block 516.

After the flow data analyzer writes flow data to the flow data log at process block 516 or at process block 530, the flow data analyzer determines whether a flow data source selection trigger was received or generated (518). The flow data analyzer may be programmed to generate a flow data source selection trigger or may receive a flow data source selection trigger from another module, such as a network monitoring application. A flow data source selection trigger may be expiration of a time period. For example, the flow data analyzer may be programmed to generate a flow data source selection trigger every fifteen seconds. Alternatively, the flow data analyzer may receive a flow data source selection trigger upon failure or addition of a network device to a network. For example, if the selected network device fails, a network monitoring application may detect the failure and send a flow data source selection trigger to the flow data analyzer. Additionally, the flow data analyzer may receive a flow data source selection trigger upon changes in network conditions. For example, a network monitoring application may determine that the network traffic load has increased and send a flow data source selection trigger to the flow data analyzer.

Receipt or generation of a flow data source selection trigger indicates that the selection process of a network device should be performed again (508). If a flow data source selection trigger was not received or generated, the flow data analyzer receives flow data from the selected network device (512).

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 306 and 308 of FIG. 3 can be performed in parallel or concurrently. With respect to FIG. 2, block 203 is not necessary in instances where identifying information for hosts in a network is provided to a flow data analyzer. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

Some operations above iterate through sets of items, such as hosts or network devices. In some implementations, network devices may be iterated over in an order based on the amount of flow data captured. Also, the number of iterations for loop operations may vary. For example, only a subset of hosts in a network may be iterated over. Additionally, a loop may not iterate for each network device. For example, a loop may exit once a network device that satisfies a set of criteria is found. The set of criteria may include a minimum sample rate, a threshold amount of flow data captured, etc.

In addition to the operations described above in FIG. 3, the flow data analyzer may be configured to assign a weight to network device sample rates and amounts of flow data captured by network devices and select a network device based on a comparison of the weighted values. The sample rate and amount of flow data captured by each of the network devices may be multiplied by weight values and added together. For example, if a network device has a sample rate of 1/10 and collected 1000 bytes of flow data, the sample rate may be multiplied by 0.8 and the collected data multiplied by 0.2 resulting in a total weighted value of 200.08. The flow data analyzer then compares the weighted values for the network devices and selects the network device with the highest weighted value.

In addition to sample rate and amount of flow data collected, a flow data analyzer may select a network device based on other criteria such as a hop count from the host to a network device. A hop count indicates the number of network components between a host and a network device. For example, if network traffic flows from a host through a first router to a second router, the host is a hop count of two away from the second router. A small hop count between a network device and a host can indicate that the network device is likely to receive network traffic from the host. To select a network device based on hop count, the flow data analyzer determines hop counts of network devices to a host and selects a network device with the smallest hop count to the host.

In some instances, a flow data analyzer may have knowledge of network topology or may be able to determine a logical topology by mapping network traffic flow between network components. Using the topology, the flow data analyzer can identify network devices that could potentially receive network traffic from a host. The flow data analyzer can select a network device that is closest to the host to be a flow data source or can select a network device that is likely to see a majority of network traffic from the host based on the network traffic flow indicated in the topology.

Although the description above refers to selecting a network device, such as a router, to be a flow data source, a flow data analyzer can also select a flow collector to be a flow data source. A flow collector collects flow data from a number of network devices and exports the aggregated flow data to the flow data analyzer. Multiple flow collectors may be used within a network. Instead of selecting a single network device, a flow data analyzer can select a flow collector to be a flow data source for a host. After selecting a flow collector, the flow data analyzer will use flow data from each network device that exports to the flow collector when determining measurements for a host.

In some instances, a selected primary flow data source may fail causing a secondary flow data source to be selected. The secondary flow data source may not capture flow data as frequently or accurately as the primary flow data source. In such instances, a flow data analyzer may adjust the flow data from the secondary source to account for the decrease in frequency or inaccuracy. For example, if the sampling rate of the primary source is two times the sampling rate of the secondary source, the flow data analyzer may multiply by two the number of packets and bytes in flow records captured by the secondary source to adjust for the decrease in sampling frequency. Additionally, the flow data analyzer may compare flow data received from the secondary source to flow data previously captured by the primary source and then adjust the flow data from the secondary source based on the comparison. For example, the flow data analyzer may determine that packet and byte numbers in the primary flow data are on average 25% higher than numbers from the secondary flow data and increase the numbers in the second flow data by 25%.

The variations described above do not encompass all possible variations, implementations, or embodiments of the present disclosure. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

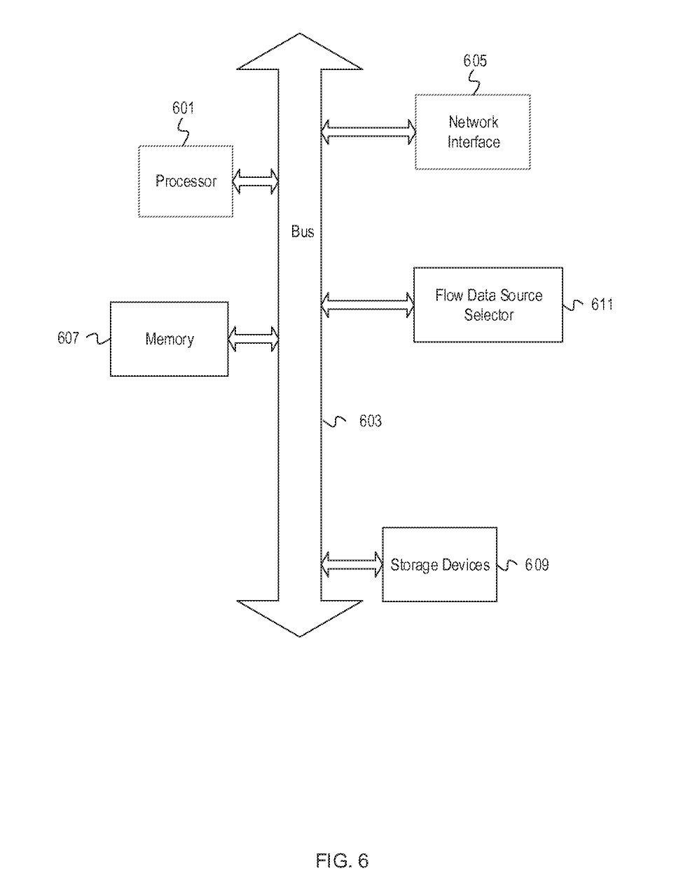

FIG. 6 depicts an example computer system with a flow data source selector. The computer system includes a processor 601 (possibly including multiple processors, multiple cores, multiple nodes, and/or implementing multi-threading, etc.). The computer system includes memory 607. The memory 607 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes storage devices 609. The storage devices 609 may be local or remote storage (e.g., a hard disk or hard disk array, a diskette, an optical storage device, a magnetic storage device, Network Attached Storage (NAS), Storage Area Network (SAN)) or any one or more of the above already described possible realizations of machine-readable media. The computer system also includes a bus 603 (e.g., PCI, ISA, PCI-Express, HyperTransport® bus, InfiniBand® bus, NuBus, etc.) and a network interface 605 (e.g., a Fiber Channel interface, an Ethernet interface, an internet small computer system interface, SONET interface, wireless interface, etc.). The system also includes flow data source selector 611. The flow data source selector 611 identifies and selects a flow data source for hosts in a network. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

While the aspects of the disclosure are described with reference to various implementations and exploitations, it will be understood that these aspects are illustrative and that the scope of the claims is not limited to them. In general, techniques for selecting flow data sources for hosts in a network as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one of . . . and” should not be construed to be exclusive. For instance, the phrase “X comprises at least one of A, B, and C” does not mean that X comprises only one of {A, B, C}; it does not mean that X comprises only one instance of each of {A, B, C}, even if any one of {A, B, C} is a category or sub-category; and it does not mean that an additional element cannot be added to the non-exclusive set (i.e., X can comprise {A, B, Z}).

What is claimed is:

1. A method comprising:
in response to identification of a host, identifying a first set of network devices, from a plurality of network devices, which have each collected data about network traffic of the host;
selecting a first network device from the first set of network devices based, at least in part, on a first selection criterion; and
identifying, for network traffic analysis, the data about network traffic of the host that was collected by the first network device.

2. The method of claim 1 further comprising:
comparing sampling frequencies of the first set of network devices, wherein the first selection criterion is highest sampling frequency;
wherein the first network device has the highest sampling frequency of the first set of network devices.

3. The method of claim 1, wherein identifying, for network traffic analysis, the data about network traffic of the host that was collected by the first network device comprises excluding, from the network traffic analysis, data about network traffic of the host that was collected by others of the first set of network devices.

4. The method of claim 1 further comprising:
identifying a first timestamp of network traffic data in a log for the host; and
writing to the log the data about network traffic of the host that was collected by the first network device after the first timestamp.

5. The method of claim 3 further comprising:
determining that a second network device should be selected from the first set of network devices instead of the first network device in response to a network traffic data source selection trigger;
in response to a determination that the second network device should be selected, selecting the second network device from the first set of network devices; and
identifying a second timestamp in the log, wherein the second timestamp corresponds to the data about network traffic of the host that was collected by the first network device after the first timestamp; and
writing to the log data about network traffic of the host that was collected by the second network device after the second timestamp; and
identifying, for network traffic analysis, data about network traffic of the host in the log.

6. The method of claim 5, wherein the network traffic data source selection trigger comprises at least one of:
an indication that the first network device has failed;
an indication that network traffic data collected by the second network device more accurately represents network traffic of the host based, at least in part, on the first selection criterion; and
an indication that another network device should be selected base, at least in part, on expiration of a time period.

7. The method of claim 1 further comprising:
comparing an amount of data about network traffic of the host collected by each of the first set of network devices, wherein the first selection criterion is largest amount of network traffic data about the host collected in a time period; and
wherein the first network device satisfied the first selection criterion in the time period.

8. The method of claim 1, wherein said selecting a first network device from the first set of network devices comprises selecting the first network device from the first set of network devices also based, at least in part, on a second selection criterion.

9. The method of claim 8 further comprising:
comparing sampling frequencies of the first set of network devices, wherein the first selection criterion is highest sampling frequency;
determining that a second set of network devices satisfy the first selection criterion, wherein the first set of network devices comprise the second set of network devices; and
comparing an amount of data about network traffic of the host collected by each of the second set of network devices, wherein the second selection criterion is largest amount of network traffic data collected in a time period;
wherein said selecting the first network device from the first set of network devices comprises selecting the first network device from the second set of network devices based, at least in part, on the first network device collecting the largest amount of network traffic data in the time period of the second set of network devices.

10. The method of claim 1, wherein said identifying the first set of network devices, from the plurality of network devices, which have each collected data about network traffic of the host comprises:
determining an identifier for the host;
for each of the plurality of network devices,
determining whether the identifier is in network traffic data collected by the network device; and
in response to a determination that the identifier is in the network traffic data collected by the network device, recording an indication of the network device.

11. One or more machine-readable storage media having program code for a network traffic data analyzer stored therein, the program code comprising instructions to:
in response to identification of a host, identify a first set of network devices, from a plurality of network devices, which have each collected data about network traffic of the host;
select a first network device from the first set of network devices based, at least in part, on a first selection criterion; and
identify, for network traffic analysis, the data about network traffic of the host that was collected by the first network device.

12. An apparatus comprising:
a processor; and
a machine-readable medium having program code executable by the processor to cause the apparatus to,
in response to identification of a host, identify a first set of network devices, from a plurality of network devices, which have each collected data about network traffic of the host;
select a first network device from the first set of network devices based, at least in part, on a first selection criterion; and
identify, for network traffic analysis, the data about network traffic of the host that was collected by the first network device.

13. The apparatus of claim 12 further comprising program code executable by the processor to cause the apparatus to:
compare sampling frequencies of the first set of network devices, wherein the first selection criterion is highest sampling frequency;
wherein the first network device has the highest sampling frequency of the first set of network devices.

14. The apparatus of claim 12, wherein the program code executable by the processor to cause the apparatus to identify, for network traffic analysis, the data about network traffic of the host that was collected by the first network device comprises program code executable by the processor to cause the apparatus to exclude, from network traffic analysis, data about network traffic of the host that was collected by others of the first set of network devices.

15. The apparatus of claim 12 further comprising program code executable by the processor to cause the apparatus to:
identify a first timestamp of network traffic data in a log for the host; and
write to the log the data about network traffic of the host that was collected by the first network device after the first timestamp;
determine that a second network device should be selected from the first set of network devices instead of the first network device in response to a network traffic data source selection trigger;
in response to a determination that the second network device should be selected, select the second network device from the first set of network devices; and
identify a second timestamp in the log, wherein the second timestamp corresponds to the data about network traffic of the host that was collected by the first network device after the first timestamp; and
write to the log data about network traffic of the host that was collected by the second network device after the second timestamp; and
identify, for network traffic analysis, data about network traffic of the host in the log.

16. The apparatus of claim 15, wherein the network traffic data source selection trigger comprises at least one of:
an indication that the first network device has failed;
an indication that network traffic data collected by the second network device more accurately represents network traffic of the host based, at least in part, on the first selection criterion; and
an indication that another network device should be selected base, at least in part, on expiration of a time period.

17. The apparatus of claim 12 further comprising program code executable by the processor to cause the apparatus to:
compare an amount of data about network traffic of the host collected by each of the first set of network devices, wherein the first selection criterion is largest amount of network traffic data about the host collected in a time period; and
wherein the first network device satisfied the first selection criterion in the time period.

18. The apparatus of claim 12, wherein the program code executable by the processor to cause the apparatus to select a first network device from the first set of network devices comprises program code executable by the processor to cause the apparatus to select a first network device from the first set of network devices also based, at least in part, on a second selection criterion.

19. The apparatus of claim 18 further comprising program code executable by the processor to cause the apparatus to:
compare sampling frequencies of the first set of network devices, wherein the first selection criterion is highest sampling frequency;
determine that a second set of network devices satisfy the first selection criterion, wherein the first set of network devices comprise the second set of network devices; and
compare an amount of data about network traffic of the host collected by each of the second set of network devices, wherein the second selection criterion is the largest amount of network traffic data collected in a time period;
wherein the program code executable by the processor to cause the apparatus to select the first network device from the first set of network devices comprises program code executable by the processor to cause the apparatus to select the first network device from the second set of network devices based, at least in part, on the first network device collecting the largest amount of network traffic data in the time period of the second set of network devices.

20. The apparatus of claim 12, wherein the program code executable by the processor to cause the apparatus to identify the first set of network devices, from the plurality of network devices, which have each collected data about network traffic of the host comprises program code executable by the processor to cause the apparatus to:
determine an identifier for the host;
for each of the plurality of network devices,
determine whether the identifier is in network traffic data collected by the network device; and
in response to a determination that the identifier is in the network traffic data collected by the network device, record an indication of the network device.
